(19) United States
(12) Patent Application Publication
(10) Pub. No.: US 2018/0113949 A1
(43) Pub. Date: Apr. 26, 2018

(54) STORY CARDS TO FACILITATE REVIEW OF SEARCH ENGINE OPTIMIZATION METRICS

(71) Applicant: Conductor, Inc., New York, NY (US)

(72) Inventors: Michael Rubino, Sunnyside, NY (US); Oleksandr Lytvyn, Kyiv (UA); Ihor Romanchenko, Kyiv (UA); Arkadii Savenkov, Kyiv (UA); Shamoun Murtza, River Edge, NJ (US); Seth Besmertnik, New York, NY (US)

(73) Assignee: Conductor, Inc., New York, NY (US)

(21) Appl. No.: 15/792,260

(22) Filed: Oct. 24, 2017

Related U.S. Application Data
(60) Provisional application No. 62/412,055, filed on Oct. 24, 2016.

(51) Int. Cl. G06F 17/30

(52) U.S. Cl. CPC G06F 17/30905; G06F 17/30864

(57) ABSTRACT

Technologies are described for generating a story card for a search engine optimization application. The methods may comprise, by a processor, receiving search engine optimization data. The methods may comprise analyzing the search engine optimization data. The methods may comprise generating a search engine optimization report based on the analysis of the search engine optimization data. The search engine optimization report may include a value for a metric. The methods may comprise processing the search engine optimization report to generate the story card in response to determining the value for the metric exceeds a threshold value. The story card may include a message. The message may include the value and the metric. The methods may comprise generating user interface data that includes the story card.

### CROSS REFERENCE TO RELATED APPLICATION

This application claims priority under 35 U.S.C. § 119(e) to provisional application U.S. 62/412,055 filed on Oct. 24, 2016, the entirety of which is hereby incorporated by reference.

### BACKGROUND OF THE INVENTION

In a search engine, a crawler aggregates pages from the Internet and ensures that these pages are searchable. The pages retrieved by the crawler are indexed by an indexer. For example, each web page may be broken down into words and respective locations of each word on the page. The pages are then indexed by the words and their respective locations. A user may send a search query to a dispatcher. The dispatcher may forward the query to search nodes. The search nodes search respective parts of the index and return search results along with a document identifier. The dispatcher merges the received results to produce a final result set displayed to a user sorted by ranking scores based on a ranking function. Users may modify web pages in an attempt to have their page appear higher in a result set for particular queries. A web page that is ranked higher on a result set or is listed more frequently within a result set may receive more visitors. Monitoring keywords and web page ranks may be useful in generating more revenue for a company and is sometimes known as search engine optimization.

### SUMMARY

According to some examples, systems effective to generate a story card for a search engine optimization application are generally described. The systems may comprise a memory including instructions. The instructions may include a search engine optimization application. The systems may comprise a processor configured in communication with the memory. The processor may be effective to execute the search engine optimization application instructions in the memory to receive search engine optimization data. The processor may be effective to execute the search engine optimization application instructions in the memory to analyze the search engine optimization data. The processor may be effective to execute the search engine optimization application instructions in the memory to generate a search engine optimization report based on the analysis of the search engine optimization data. The search engine optimization report may include a value for a metric. The processor may be effective to execute the search engine optimization application instructions in the memory to process the search engine optimization report to generate the story card. The story card may include a message. The message may include the value and the metric. The processor may be effective to execute the search engine optimization application instructions in the memory to generate user interface data that includes the story card.

According to other examples, methods to generate a story card for a search engine optimization application are generally described. In some examples, the methods may comprise, by a processor, receiving search engine optimization data. The methods may comprise analyzing the search engine optimization data. The methods may comprise generating a search engine optimization report based on the analysis of the search engine optimization data. The search engine optimization report may include a value for a metric. The methods may comprise processing the search engine optimization report to generate the story card in response to determining the value for the metric exceeds a threshold value. The story card may include a message. The message may include the value and the metric. The methods may comprise generating user interface data that includes the story card.

According to further examples, story cards for a search engine optimization application are generally described. The story cards may comprise a message. The message may include a value and a metric. The value and the metric may be based on an analysis of data from the search engine optimization application, a report of the search engine optimization application, and a determination that the value for the metric exceeds a threshold value. The story cards may comprise an indication of a time period. The story cards may comprise a user interface. The user interface may be effective to provide a click path to the report of the search engine optimization application that includes the analysis of the data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a system drawing of a system in accordance with an embodiment of the invention.

FIG. 2 is a drawing illustrating a user interface in accordance with an embodiment of the invention.

FIG. 3 is a flow diagram illustrating a method which may be performed in accordance with an embodiment of the invention.

### DETAILED DESCRIPTION

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

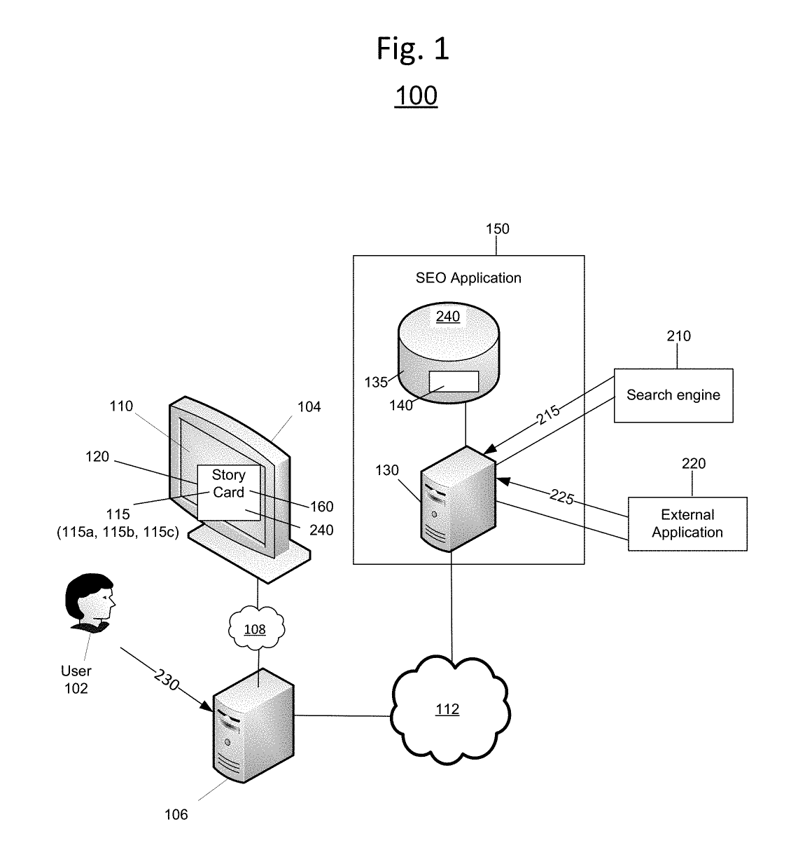

FIG. 1 is a system drawing of a system in accordance with an embodiment of the invention. System 100 may include a display 104 and a processor 106 configured in communication through a network 108. Network 108 could include, for example, the Internet or a Local Area Network (“LAN”). Processor 106 may be in communication with a processor 130 through a network 112. Processor 130 may be in communication with a memory 135 including instructions 140. Processor 130 may be part of a search engine optimization application 150 and may be effective to provide search engine optimization data including metric updates and reports for digital marketing as discussed in more detail below. Network 112 may be the Internet, a wide area network and/or a local area network. Network 112 may or may not be the same network as network 108.

Processor 130 may further be in communication with a search engine 210 and an external application 220. Search engine 210 could be, for example, the GOOGLE search engine, the YAHOO! search engine, BING, etc. Processor 130 may receive search engine data 215 from search engine 210. Search engine data 215 may include a search engine results page (“SERP”). Processor 130 may analyze search engine data 215 and generate a story card 120 based on the analysis of search engine data 215.

External application 220 may be an application different from search engine optimization application 150 and may include WEB ANALYTICS, DAILY RANK TRACKING, MONTHLY SEARCH VOLUME (MSV), SOCIAL, GOOGLE SEARCH CONSOLE, DEEPCRAWL, SEMRUSH, GOOGLE ANALYTICS, ADOBE ANALYTICS, IBM DIGITAL ANALYTICS, WEBTRENDS, and MOZ. Processor 130 may receive external analytic data 225 from external application 220. External analytic data 225 may include data sets from external application 220. External analytic data 225 may include, for example, a broad set of data related to user interactions on a website. In an example, external application 220 may be the GOOGLE SEARCH CONSOLE (GSC) and story card 120 may be generated from external analytic data 225 received from GSC. In such an example, search engine optimization application 150 may analyze external analytic data 225 from GSC, generate story card 120 based on the analysis of external analytic data 225, present story card 120 to a user 102, and then generate and display a link for user 102 to navigate back to the relevant GSC report directly from search engine optimization application 150. In brief, processor 130 may use an application programming interface (API) to send a hypertext transfer protocol message (HTTP) to process search engine data 215 and external analytic data 225 to identify metrics and values for such metrics over a defined threshold. If such values are determined to be in excess of the defined threshold, processor 130 may process search engine data 225 and external analytic data 225 by adding a message to the relevant values and metrics to produce story card 120.

Story card 120 may be generated by processor 130 executing instructions 140 in memory 135 of search engine optimization application 150. Processor 130 may receive search engine data 215 from search engine 210 and/or external analytic data 225 from external application 220. Processor 130 may analyze search engine data 215 and/or external analytic data 225. Processor 130 may generate search engine optimization report 170 based on the analysis of search engine data 215 and/or external analytic data 225. Processor 130 may process search engine optimization report 170 to generate story card 120. Processor 130 may determine a presence of a threshold value for a metric in search engine optimization report 170 and generate story card 120 in response to the presence of the threshold value. Story card 120 may include the value, the metric, and a message. Story card 120 may include a message that is human-readable in natural language. Processor 130 may generate story card 120 by populating a specific message with the value and the metric in response to the presence of a threshold value for the metric in search engine optimization report 170. Processor 130 may generate user interface data for story card 120. Data stream 180 of user 102 may include user interface data for story card 120. Processor 130 may send data stream 180 to user interface 110.

Story card 120 may provide insight into search engine optimization and digital marketing to user 102. Story card 120 may include a summary of a story 115. Story card 120 may provide user 102 with an update on a search engine optimization metric related to a story 115, and may relate to a search engine optimization or digital marketing effort of user 102. Story 115 may include refined stories 115a, multi-data source stories 115b, and high level user stories 115c. Refined story 115a may be generated by search engine optimization application 150 based on search engine data 215. Multi-data source story 115b may combine data sets available to search engine optimization application 150, including page performance data from analytics, rank, and Monthly Search Volume (MSV) data from SERP crawls. As explained in more detail below, multi-data source story 115b may allow user 102 to correlate search engine optimization metrics such as web traffic and search visibility fluctuations with comments saved to story card 120. Multi-data source story 115b may include external application data 225. High level user story 115c may be prioritized and customized by user 102 of search engine optimization application 150.

Story card 120 may be generated by processor 130 for user 102 based on an account of user 102. Story card 120 may be published to data stream 180 of user 102, a subset of all users of an account of search engine optimization application 150, or all the users in the account of search engine optimization application 150.

Display 104 may be configured to display a user interface 110. User interface 110 may include story card 120. Story card 120 may include human-readable natural language, and may include a user interface 160 with a link that user 102 can activate to navigate to a relevant report of search engine optimization application 150. Story card 120 may include a representation of a value for a metric based on processor 130 analyzing search engine data 215 and/or external analytic data 225 and processing report 170. Story card 120 may include a notification of an insight related to search engine optimization. Story card 120 may include a highlight of a piece of interesting information to gain the attention of user 102. Story card 120 may include an indication of a time period tied to story card 120. Story card 120 may be a “jumping-off point” for user 102 to perform an action within search engine optimization application 150. Story card 120 may be looked at as a springboard, or a trigger point within search engine optimization application 150. Story card 120 may be published by search engine optimization application 150 periodically.

User 102 may have the ability to “Hide” story card 120 from data stream 180 of user 102 through interface 110. User 102 may be able to “Hide” story card 120 based on the type of story 115 associated with story card 120. For example, user 102 may instruct processor 106 to hide stories of a particular type. User 102 may be able to “Unhide” story card 120 from data stream 180 through user interface 110 based on the type of story 115 associated with story card 120.

User interface 160 may enable communication between user 102 and another user or team of users that have story card 120 published to their respective data streams. Processor 106 and user interface 160 of story card 120 may enable user 102 to send a communication 230 with reference to story card 120 and may include data 240. Communication 230 may include comments or callouts to be posted to story card 120. Communication 230 may promote sharing of information between users that have story card 120 published to their respective data streams. Processor 130, in communication with processor 106, and user interface 160 may save communication 230 in connection with story card 120 in memory 135 as data 240. Data 240 may be stored as a record of a team's interactions and decisions on story card 120.

Story card 120 may include a value important to a business of user 102. Story card 120 may include data 240. Data 240 may include comments posted to story card 120 by user 102. Data 240 may detail information including what actions have taken place with regard to story card 120, what decisions have been made about story card 120, and what user 102 has done in relation to story card 120. Data 240 posted to story card 120 may include comments posted to story card 120 and may be stored in memory 135. Comments posted to story card 120 in data 240 may give context to a value and metric update that story card 120 may include. For example, user 102 may post a comment to story card 120 stating a webpage was updated. In an example, story card 120 may include a value and metric which have changed in a positive direction. Comments in data 240 of story card 120 may provide the context of the web page update increasing the value and metric shown in story card 120.

Story card 120 may have a life span. Processor 130 may analyze search engine data 215 and/or external analytic data 225 and determine a life span for story card 120 based on the analysis. Processor 130 may analyze search engine data 215 and/or external analytic data 225 and determine an importance/relevance of story card 120 may decay over time. Processor 130 may determine a half-life for story card 120. Processor 130 may determine a half-life for story card 120 based upon story card 120 story 115. Processor 130 may determine a half-life of story 115 based on the temporality of its contents.

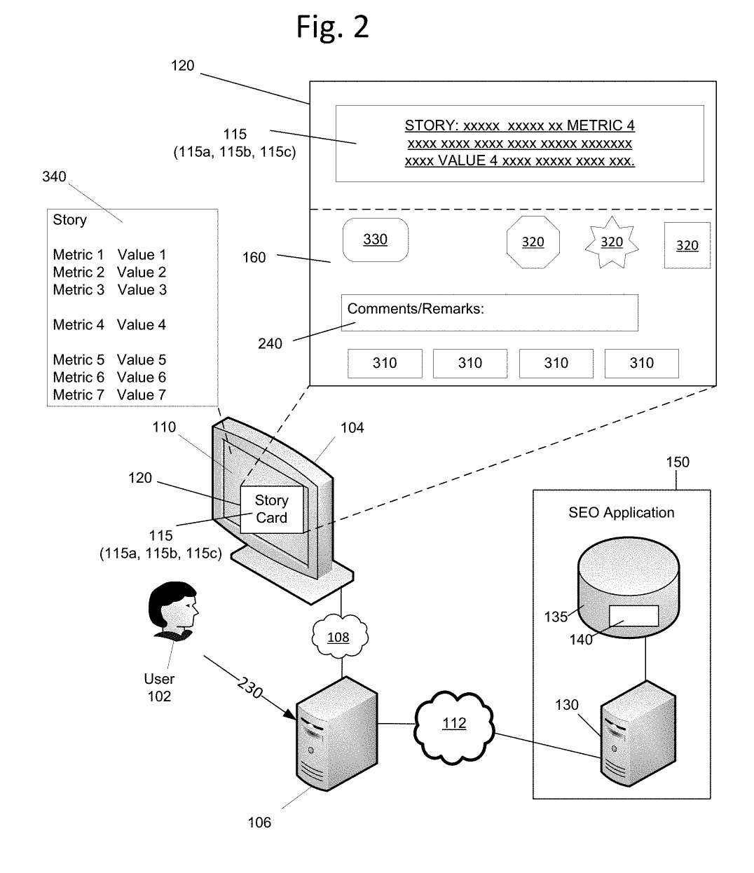

FIG. 2 is a drawing illustrating a story card and user interface in accordance with an embodiment of the invention. Those components in FIG. 2 that are labelled identically to components of FIG. 1 will not be described again for the purposes of clarity.

Interface 110 may include story card 120. Story card 120 may be displayed visually distinct to user 102 on interface 110 based on a published date of story card 120. For example, story card 120 may be new and have been published in a time period since user 102 last loaded interface 110. A story card 120 that is new may be displayed visually distinct from other story cards 120 that were visible in data stream 180 of user 102 at a previous load of interface 110. For example, story card 120 that is new may be displayed by interface 110 to include a different color, size, font (bold, italic), etc. so as to be visually distinct from other story cards 120.

User 102 may be able to send communication 230 through user interface 160 of story card 120. Communication 230 may allow user 102 to perform various functions related to story card 120. User 102 may send communication 230 through user interface 160 to navigate to a relevant search engine optimization application report 170 or third-party platform report 170. Processor 130 may receive communication 230 through user interface 160 and in response generate relevant search engine optimization application report 170 or third-party platform report 170.

User interface 160 of story card 120 may include one or more Call To Action (CTA) buttons 310. User 102 may take click on CTA button 310 and send communication 230 to processor 130 through user interface 160. In response to receiving communication 230, processor 130 may execute an action as defined by CTA button 310. In an example, user 102 may send communication 230 to processor 130 through user interface 160 of story card 120. Communication 230 may be to share comments with other users, tag another user, or to create a dialogue about an insight of story card 120. Processor 130 may receive communication 230 and in response generate a dialog box on user interface 160 of story card 120. In another example, user 102 may send communication 230 to user interface 160 of story card 120 to email stakeholders and inform them about story card 120 or to encourage them to log into the search engine optimization application 150. Processor 130 may receive communication 230, and in response, generate an email to users associated with story card 120.

User 102 may not want to see story card 120 on data stream 180 of user 102. User 102 may send communication 230 to processor 130 to hide story card 120 and remove story card 120 from data stream 180 of user 102. User 102 may send communication 230 to hide a particular type of story 115 from data stream 180 of user 120. User 102 may “personalize” the types of stories published in the future to data stream 180 of user 102. In response to communication 230 processor 130 may generate options on user interface 160 of story card 120 for user 102 to select a type of story 115 to remove from data stream 180 of user 102. User 102 may hide a story 115 based on the domain the story is reporting on, the type of content in the story, etc. In response to receiving a selection of a type of story 115 to hide in communication 230, processor 106 may remove and hide future occurrences of story card 120 that include story 115 from data stream 180 of user 102.

User interface 160 of story card 120 may include an alert 320. Processor 130 may generate alert 320 on user interface 160 to proactively highlight a critical issue to user 102 based on an analysis of search engine data 215 and/or external analytic data 225. User interface 160 may enable user 102 to customize alert settings (thresholds, messages, etc.) of alert 320. User interface 160 may enable user 102 to select a type of alert 320 so as to tailor alert 320 to be relevant to user 102. Alert 320 may be at the top of data stream 180 of user 102 and user 102 may associate data stream 180 with “alert-style” information. Alert 320 may increase a desire of user 120 to customize story card 120 in data stream 180 of user 120. User 120 may desire to have control over what may be displayed on story card 120. Alert 320 may be prescribed by a search engine optimization application 150, and may include business-specific information and configuration.

In an example, alert 320 for story card 120 may read “Win! Search Console identified one hundred and seventy-one searches where your content is getting seen a lot AND clicked on often. This indicates that when people search for these terms, they're finding your content and it's aligned with their intent.” In another example, alert 320 for story card 120 may read “Nice Job! Search Console identified thirty-two searches where niche audiences (low impressions) click on your content often (high CTR). This means your content is in line with their intent.” In another example, alert 320 may read “Search Console identified twelve searches where your content is getting seen a lot (high impressions) but aren't clicking on it very often. Consider reviewing the content you have ranking for these searches to optimize and take advantage of the high impressions.”

User interface 160 may include one or more filters 330. Filters 330 may allow user 120 to communication with processor 106 and processor 130 to remove stories or story types from user interface 160. For example, user 102 may request that all stories of a particular type be “hidden” and those stories will not be published to user interface 160 until user 102 chooses to reveal such stories.

User 102 may send communication 230 through user interface 160 to navigate from story card 120 to a search engine optimization application report 170. In an example, user interface 160 may include Call to Action button 310. Upon Call to Action button 310 being clicked by user 102, processor 130 may direct user 102 to a report 170 of search engine optimization application 150 with data relevant to story card 120. Search engine optimization application report 170 may maintain the context of story card 120. Processor 130 may query search engine optimization application to generate search engine optimization report 170 with an adjusted view of elements of report 170 so as to match story card 120 insight. In an example, story card 120 may read “You moved onto the first page for twenty-six searches last week” and user 102 may want to view search engine optimization application report 170 “Visibility Performance”. User 102 may click on CTA button 310 for “Visibility Performance” through user interface 160. Processor 130 may query search engine optimization application 150 to generate Visibility Performance report 170 with a summary that matches story card 120 highlighted and report 170 sorted to match story card 120. Processor 130 may send report 170 to interface 110. Report 170 may include a headline or notification of story card 120 which may be displayed at the top of report 170 to maintain context and remind user 102 why user 102 came to report 170. Data 240, including comments, share, tasks, etc. of story card 120, may not be included or visible on report 170. Elements of report 170 may be moved or adjusted within report 170 to better display information to user 102 pertaining to story card 120. Elements within report 170 that may be adjusted may include: Domain, Search Engine, Report Time Period, Comparison Time Period, Locale, Device Type, Category/Categories, Content Segment(s), Metric(s), Screen Element Highlighting (e.g. highlighting the relevant Visibility Performance summary card or ASE card), Table Filtering, Table Sorting, Table Column Visibility, Screen Position, Scrolling, and Anchoring.

In an example, story card 120 may include story 115 based on visibility performance. Story card 120 may relate to a URL of user 102 that has moved onto the first page for forty-three searches the previous week. In such a case, story card 120 may present the three highest-volume searches. In another example, a story card 120 may be related to a URL of user 120 that has dropped off the first page for sixteen searches the previous week. Story card 120 may present the three highest-volume searches so that user 102 may research to determine what changed.

In another example, story card 120 may be related to a URL of user 102 that has moved into the top three results for eight searches the previous week. Story card 120 may then present the three highest-volume searches. In another example, a story card 120 may be related to a URL of user 102 that has dropped out of the top three results for six searches the previous week. Story card 120 may then present the three highest-volume searches so that user 102 may research to determine what changed.

In another example, story card 120 may be related to a URL of user 102 that has moved up into “Striking Distance” for twenty-five searches the previous week. Story card 120 may present the three highest-volume searches and a rank of the URL in each search. User 102 may explore optimizing the page ranking for these searches to move onto page one and substantially increase visibility. In another example, story card 120 may be related to a URL of user 102 that is no longer ranking for one hundred twenty-three searches that the URL was ranking for the previous week.

Among other potential benefits, a system in accordance with the disclosure may provide insight from multiple datasets to a user. A user of a system in accordance with the disclosure may receive insights into a report without having to parse the report. A user of a system in accordance with the disclosure may save time in determining search engine optimization actions to take. A user of a system in accordance with the disclosure may be able to better focus on actions to improve search engine optimization rather that stitching data together.

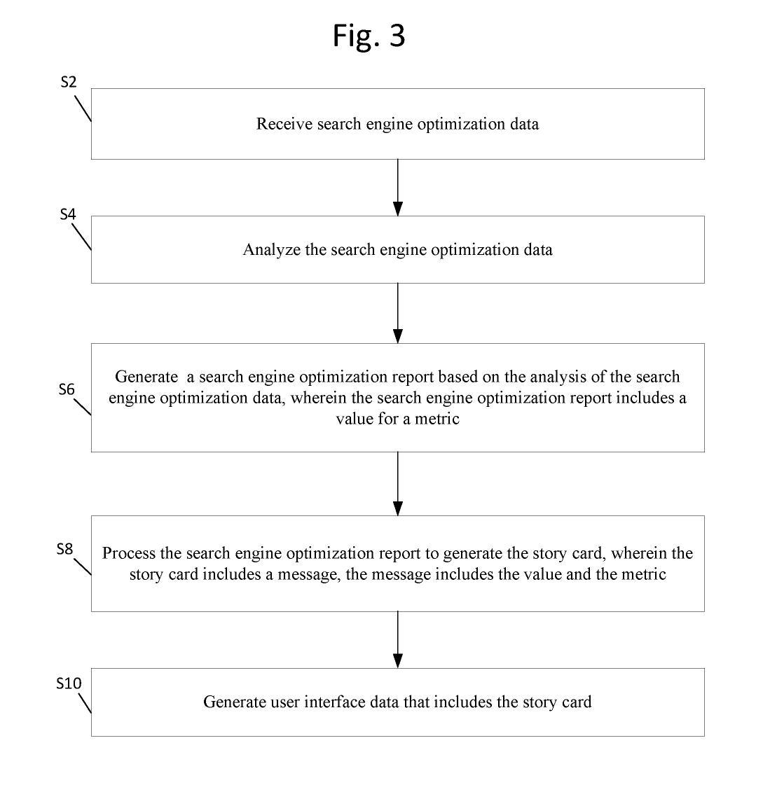

FIG. 3 is a flow diagram illustrating a method which may be performed in accordance with at least some embodiments presented herein. The method in FIG. 3 could be implemented using, for example, system 100 discussed above. The example method may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2 “Receive search engine optimization data.” At block S2, the processor may receive search engine optimization data. The search engine optimization data may be received from a search engine or from an external application different from the search engine optimization application. The search engine could be the GOOGLE search engine, the YAHOO! search engine, BING, etc. The external application may include WEB ANALYTICS, RANK DAILY RANK TRACKING, MSV, SOCIAL, GOOGLE SEARCH CONSOLE, DEEPCRAWL, SEMRUSH, and MOZ.

Processing may continue from block S2 to block S4 “Analyze the search engine optimization data.” At block S4, the processor may analyze the search engine optimization data.

Processing may continue from block S4 to block S6 “Generate a search engine optimization report based on the analysis of the search engine optimization data, wherein the search engine optimization report includes a value for a metric.” At block S6, the processor may generate a search engine optimization report. The search engine optimization report may be based on the analysis of the search engine optimization data. The search engine optimization report may include a value for a metric.

Processing may continue from block S6 to block S8 “Process the search engine optimization report to generate the story card in response to determining the value for the metric exceeds a threshold value, wherein the story card includes a message, the message includes the value and the metric.” At block S8, the processor may process the search engine optimization report to generate the story card. The processor may generate the story card in response to determining the value of the metric exceeds a threshold value. The story card may include a message. The message may include the value and the metric.

Processing may continue from block S8 to block S10 “Generate user interface data that includes the story card.” At block S10, the processor may generate user interface data. The user interface data may include the story card.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system effective to generate a story card for a search engine optimization application, the system comprising:
a memory including instructions, wherein the instructions include a search engine optimization application;
a processor configured in communication with the memory, the processor being effective to execute the search engine optimization application instructions in the memory to:
receive search engine optimization data;
analyze the search engine optimization data;
generate a search engine optimization report based on the analysis of the search engine optimization data, wherein the search engine optimization report includes a value for a metric;
process the search engine optimization report to generate the story card, wherein the story card includes a message, the message includes the value and the metric; and
generate user interface data that includes the story card.

2. The system of claim 1, wherein the story card further includes an indication of a time period relating to the value and the metric.

3. The system of claim 1, wherein the story card includes a link to the search engine optimization report.

4. The system of claim 1, wherein the search engine optimization data is received from a search engine.

5. The system of claim 4, wherein the search engine optimization data is further received from an external application different from the search engine.

6. The system of claim 1, wherein the story card includes an alert.

7. The system of claim 1, wherein the processor further processes the search engine optimization report to determine a presence of a threshold value for the metric in the search engine optimization report and generates the story card in response to the presence of the threshold value.

8. The system of claim 1, wherein:
the story card is a first story card with a first message;
the value is a first value; and
the metric is a first metric;
the processor is further configured to
process the search engine optimization report to generate a second story card, wherein the second story card includes a second message that includes a second value and a second metric;
update the user interface data to include the second story card;
receive a request to remove the first story card; and
update the user interface data to remove the first story card and maintain the second story card.

9. The system of claim 1, wherein the processor is further configured to save the user interface data to the memory.

10. The system of claim 1, wherein the processor is further configured to:
receive a comment; and
update the user interface data to include the comment.

11. The system of claim 10, wherein the processor is further configured to save the updated user interface data to the memory.

12. A method to generate a story card for a search engine optimization application, the method comprising, by the processor:
receiving search engine optimization data;
analyzing the search engine optimization data;
generating a search engine optimization report based on the analysis of the search engine optimization data, wherein the search engine optimization report includes a value for a metric;
determining the value for the metric exceeds a threshold value;
processing the search engine optimization report to generate the story card in response to determining the value for the metric exceeds a threshold value, wherein the story card includes a message, the message includes the value and the metric; and
generating user interface data that includes the story card.

13. The method of claim 12, wherein the story card further includes an indication of a time period relating to the value and the metric.

14. The method of claim 12, wherein the story card includes a link to the search engine optimization report.

15. The method of claim 12, wherein the search engine optimization data is received from a search engine.

16. The method of claim 15, wherein the search engine optimization data is further received from an external application different from the search engine.

17. The method of claim 12, wherein the story card includes an alert.

18. A story card for a search engine optimization application, the story card comprising:
a message, wherein the message includes a value and a metric based on an analysis of data from the search engine optimization application, based on a report of the search engine optimization application, and based on a determination that the value for the metric exceeds a threshold value; and
a user interface effective to provide a link to the report of the search engine optimization application that includes the analysis of the data.

19. The story card of claim 18, wherein the search engine optimization data is received from a search engine.

20. The story card of claim 19, wherein the search engine optimization data is further received from an external application different from the search engine.
